(19) United States
(12) Patent Application Publication
(10) Pub. No.: US 2005/0010592 A1
(43) Pub. Date: Jan. 13, 2005

(54) Method and system for taking a data snapshot

(76) Inventor: John Guthrie, Woodinville, WA (US)

Correspondence Address: PERKINS COIE LLP;PATENT-SEA, P.O. BOX 1247, SEATTLE, WA, 98111-1247, US

(21) Appl. No.: 10/616,411

(22) Filed: Jul. 8, 2003

(51) Int. Cl. G06F 17/00

(52) U.S. Cl. 707/104.1

(57) ABSTRACT

A method and system for creating a snapshot of data. The snapshot system creates a snapshot of data that is hierarchically organized, such as the data of a file system. When a snapshot is to be created, the snapshot system copies the root node of the hierarchical organization to a new root node that points to the same child nodes as the copied root node. This new root node becomes the root node of the snapshot data. When a current node is subsequently modified, the snapshot system replaces each ancestor node of that node that has not yet been replaced with a new node that has the same child nodes as the replaced node. The snapshot system also replaces the node to be modified with a new node that points to the same child nodes of the replaced node.

### TECHNICAL FIELD

The described technology relates generally to creating a snapshot of data.

### BACKGROUND

Various techniques have been used to create snapshots of file system data. A snapshot represents the state of the data at the time the snapshot was taken. Thus, snapshots are static in the sense that the snapshot data does not change as the underlying file system data changes. The creating of snapshots has proved to be a very useful tool for backup and recovery of file system data. It has also proved useful in tracking changes to data that occur over time.

Because the file system data can be extremely large in the gigabyte and terabyte ranges, it would be prohibitively expensive both in terms of time and space to simply make a duplicate copy of the file system data for each snapshot. To avoid this expense, techniques have been developed in which snapshots can be created without having to copy all the file system data. One such technique is referred to as a “copy-on-write” technique. The copy-on-write technique does not copy the entire file system data when the snapshot is taken but defers the copying of data until the file system data is changed. So, for example, when a file is modified, a copy of the unmodified file is created as part of the snapshot and the original file can then be modified. When such a snapshot is to be created, the copy-on-write techniques typically copy all the directory information of the file system as part of the snapshot without copying the data of the files themselves. The copying of the data of the files is deferred until each file is modified. Although the copying of only the directory information at the time the snapshot is created results in a significant savings in both time and space, the directory information of a very large file system may itself be very large and thus be expensive both in terms of time and space to copy.

It would be desirable to have a snapshot technique that would avoid the expense both in terms of the time and space in copying the directory information at the time a snapshot is created.

### BRIEF DESCRIPTION OF THE DRAWINGS

FIG. 1 is a block diagram illustrating data within a hierarchically organized file system in one embodiment.

FIG. 2 is a block diagram illustrating data within the hierarchically organized file system after a snapshot has been created in one embodiment.

FIG. 3 is a block diagram illustrating data within the hierarchically organized file system after node 2 was modified in one embodiment.

FIG. 4 is a block diagram illustrating data within the hierarchically organized file system after node 4 was modified in one embodiment.

FIG. 5 is a block diagram illustrating data within the hierarchically organized file system after a second snapshot was created in one embodiment.

FIGS. 6A and 6B illustrate the setting of the aliased as and aliased by fields in one embodiment.

FIG. 7 is a block diagram illustrating the organization of the snapshot system in one embodiment.

FIG. 8 is a flow diagram illustrating the processing of a create snapshot component of the snapshot system in one embodiment.

FIG. 9 is a flow diagram illustrating the processing of a component that adds a node to a snapshot in one embodiment.

FIG. 10 is a flow diagram illustrating the processing of the set versions component in one embodiment.

FIG. 11 is a flow diagram illustrating the processing of a component to write to a file in one embodiment.

### DETAILED DESCRIPTION

A method and system for creating a snapshot of data is provided. In one embodiment, the snapshot system creates a snapshot of data that is hierarchically organized, such as the data of a file system. For example, the data may be stored in files and organized by folders or directories. The files and directories are referred to as “nodes.” The UNIX file system refers to such nodes as “inodes.” When a snapshot is to be created, the snapshot system copies the root node of the hierarchical organization to a new root node that points to the same child nodes as the copied root node. This new root node becomes the root node of the snapshot data. The nodes within the snapshot data are referred to as snapshot nodes, and the nodes within the current data are referred to as the current nodes. When a current node is subsequently modified, the snapshot system replaces each ancestor node of that node that has not yet been replaced with a new node that has the same child nodes as the replaced node. The snapshot system also replaces the node to be modified with a new node that points to the same child nodes of the replaced node. The replaced nodes become snapshot nodes and represent the state of the data at the time the snapshot was taken. In this way, the creating of a snapshot involves minimal copying of node information at the time the snapshot is created and defers the copying or replacing of other nodes until the node or one of its descendent nodes is modified. Moreover, only the nodes that are actually modified and their ancestor nodes are copied. One skilled in the art will appreciate that although the root node is described as being copied when a snapshot is created, that copying can be deferred until the first modification to the data after the snapshot is taken.

In one embodiment, the snapshot system creates and makes available multiple snapshots representing different states of the data at various times. Whenever a new snapshot is created, the snapshot system copies the current root node of the data to a new root node. The copied root node becomes the root node for the snapshot. To keep track of which nodes have been replaced during which snapshots, the snapshot system records information indicating the snapshot during which each node was last modified. For example, a new node may have an attribute that indicates the snapshot at the time the new node was created. Whenever a current node is modified, the snapshot system identifies the highest ancestor node that has not yet been replaced during the current snapshot. The snapshot system then replaces that ancestor node and its descendent nodes down to the node that is being modified. As the nodes are replaced, the snapshot system sets each new node to point to the child nodes of the replaced node. When a node is replaced, its parent node is set to point to the new node. In this way, the replaced nodes that form the snapshot point to current child nodes and to the replaced nodes that are snapshot nodes.

In one embodiment, a node can be marked as to not be part of a snapshot. In such a case, the node and its descendent nodes are not replaced when they are modified. The snapshot system can store an indication in a snapshot identifier field of the node that it is not to be part of a snapshot. When a descendent node is modified, the snapshot system identifies such a node as it looks for the highest ancestor node that has not yet been replaced during the current snapshot. When such an ancestor is identified, the snapshot system performs the requested modification without replacing any nodes.

File systems, such as the UNIX file system, typically assign a unique node identifier to each node, referred to as an “actual identifier” in the following. Application programs accessing the file system are provided with the actual identifier, or a file handle derived from the actual identifier, for use in accessing the node. When the snapshot system replaces a node, the new node has a new actual identifier that is different from the actual identifier of the replaced node. Application programs that had been provided with the actual identifier of the replaced node would then access the replaced node rather than the new node. To prevent this, the snapshot system provides “virtual identifiers” to application programs, rather than the actual identifiers. The snapshot system maintains a mapping (or association) between actual identifiers and virtual identifiers. When an application program requests a handle to a node in the current data, the snapshot system returns to the virtual identifier, rather than the actual identifier. Because the application program has only virtual identifiers, when the application program subsequently attempts to access the current data, it provides a virtual identifier. The snapshot system uses the mapping to find the corresponding actual identifier and directs the access to that node. When a node is first created by file system and it has not yet been replaced by the snapshot system, then the snapshot system uses the actual identifier as the virtual identifier. When the node is replaced, the snapshot system sets the virtual identifier of the replacing node to the virtual identifier of the replaced node. The snapshot system also uses the virtual identifier for the replaced nodes that become part of the snapshot data. The snapshot system sets the virtual identifier of the replaced node to the virtual identifier of the replacing node. When an application program accesses a snapshot node, the snapshot system returns the virtual identifier of that node along with a flag set (e.g., the high order bit of the virtual identifier set) to indicate that the virtual identifier corresponds to a snapshot node. When the application program accesses a node identified by a virtual identifier with the flag set, the snapshot system limits the access to the node as appropriate for a snapshot node (e.g., read only).

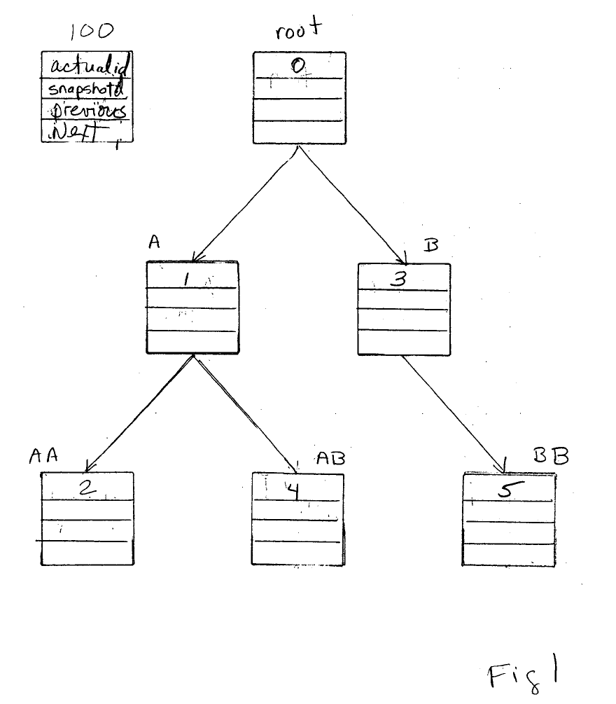

FIG. 1 is a block diagram illustrating data within a hierarchically organized file system in one embodiment. The nodes of the file system are referred to as current nodes and are uniquely identified by their node identifiers. Template 100 illustrates the fields of the node. As illustrated by template 100, each node includes an actual identifier field, a snapshot identifier field, a previous field, and next field. The node identifier field contains the unique actual identifier assigned by the file system. For example, the root node currently contains the actual identifier 0, and its child nodes contain the actual identifiers 1 and 3. The snapshot identifier fields identifies the current snapshot at the time the node was created to replace an existing node. In this example, since no snapshot has yet been created, all the snapshot identifier fields are blank. The previous and next fields are used to track snapshot nodes representing past versions of a current node. The fields form a doubly linked list. For purposes of illustration, each of the nodes includes an alphabetic identifier. For example, node 2 has the identifier “AA.” One skilled in the art would appreciate that nodes of a file system would typically contain many more fields such as a reference count or link count field, pointer fields to the data, various attribute fields, and so on.

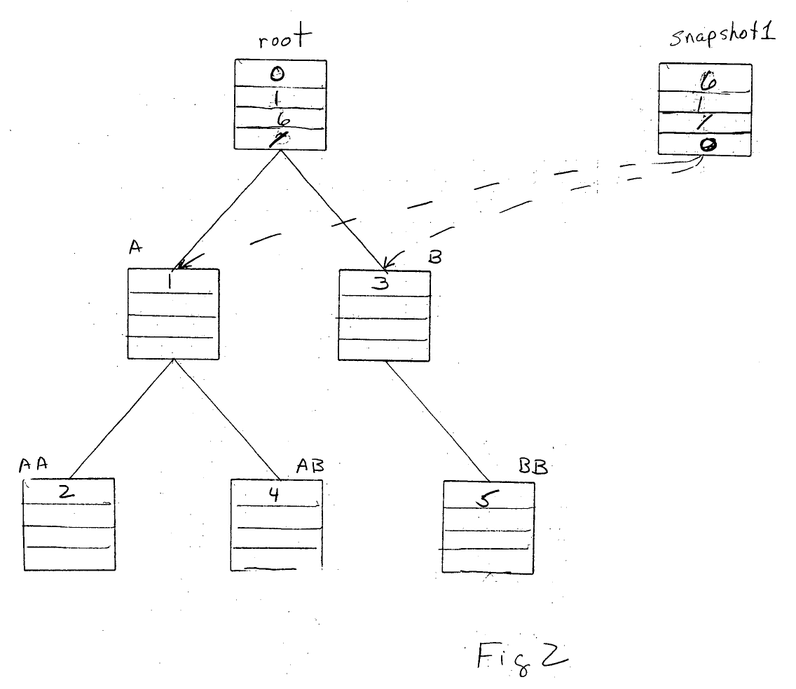

FIG. 2 is a block diagram illustrating data within the hierarchically organized file system after a snapshot has been created in one embodiment. To create the snapshot, the snapshot system created a new node 6 and incremented the snapshot identifier of node 0 to 1. The snapshot system copied the data of root node 0 to the root node 6 of the snapshot. As a result, node 6 points to the same child nodes as node 0. In addition, the snapshot system set the snapshot identifier field of node 6 to 1. The snapshot system also sets the previous and next fields. The previous field of node 0 points to node 6, and the next field of node 6 points to node 0.

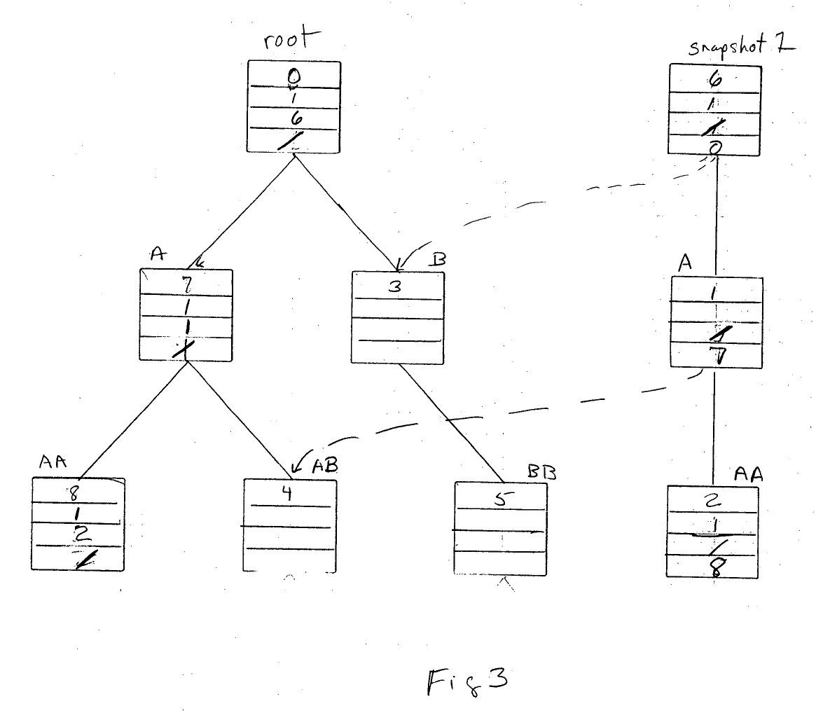

FIG. 3 is a block diagram illustrating data within the hierarchically organized file system after node 2 was modified in one embodiment. When the snapshot system received an indication that node 2 was to be modified, it located the highest ancestor node in the hierarchy that had not yet been replaced during the current snapshot. In this case, the highest such ancestor node was a node 1. The snapshot system then created a new node identified as node 7. The snapshot system copied the data from node 1 to node 7, set the snapshot identifier of node 7 to 1, and set the previous field of node 7 to 1. The snapshot system also set the next field of node 1 to 7. The snapshot system then created a new node for the node being modified. The new node is identified as node 8. The snapshot system copied the data from node 2 to node 8. It also set the snapshot identifier field of node 8 to 1 and set the previous field of node 8 to 1. If node 2 was a file node, then the snapshot system created a copy of the file data for node 2 and then modified the file data of node 8. Alternatively, the snapshot system may leave node 2 pointing to the unmodified data and allocate new data blocks for node 8. Nodes 6, 1, and 2 are snapshot nodes that are part of snapshot 1, and the rest of the nodes are current nodes.

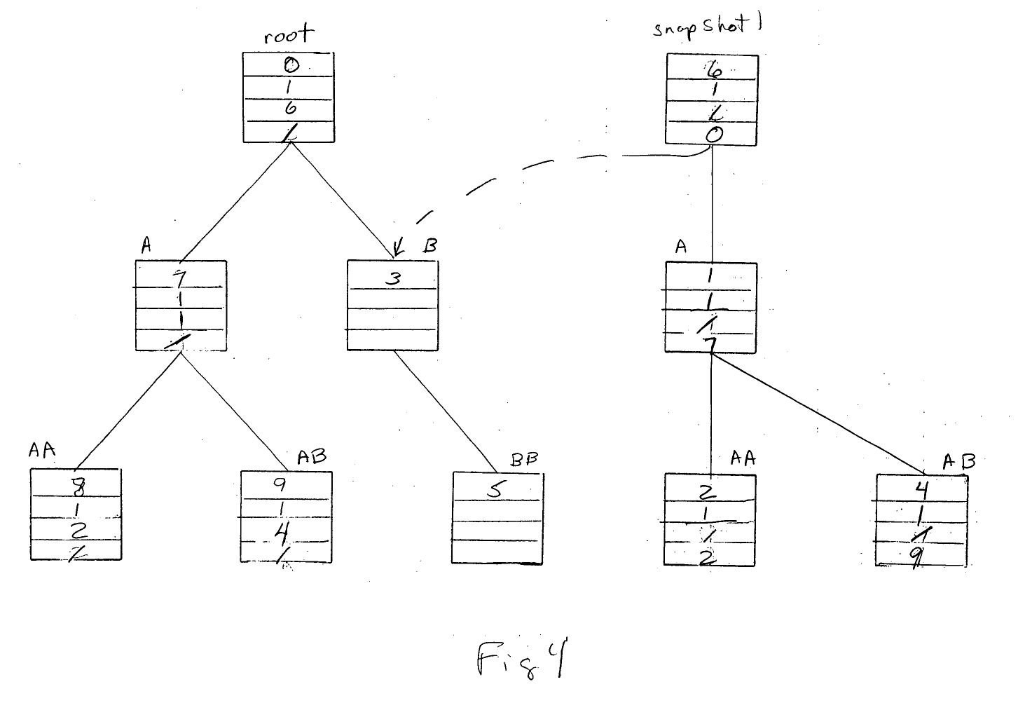

FIG. 4 is a block diagram illustrating data within the hierarchically organized file system after node 4 was modified in one embodiment. When the snapshot system received an indication that node 4 was to be modified, it determined that all of its ancestor nodes had already been replaced in the current snapshot. In particular, its parent node 7 has the current snapshot identifier in its snapshot identifier field. As a result, the snapshot system created a new node for node 4, which is identified as node 9. The snapshot system than copied the data of node 4 to node 9 and set its fields in much the same way as was done when node 2 was modified. Nodes 6, 1, 2, and 4 are snapshot nodes that are part of snapshot 1, and the rest of the nodes are current nodes.

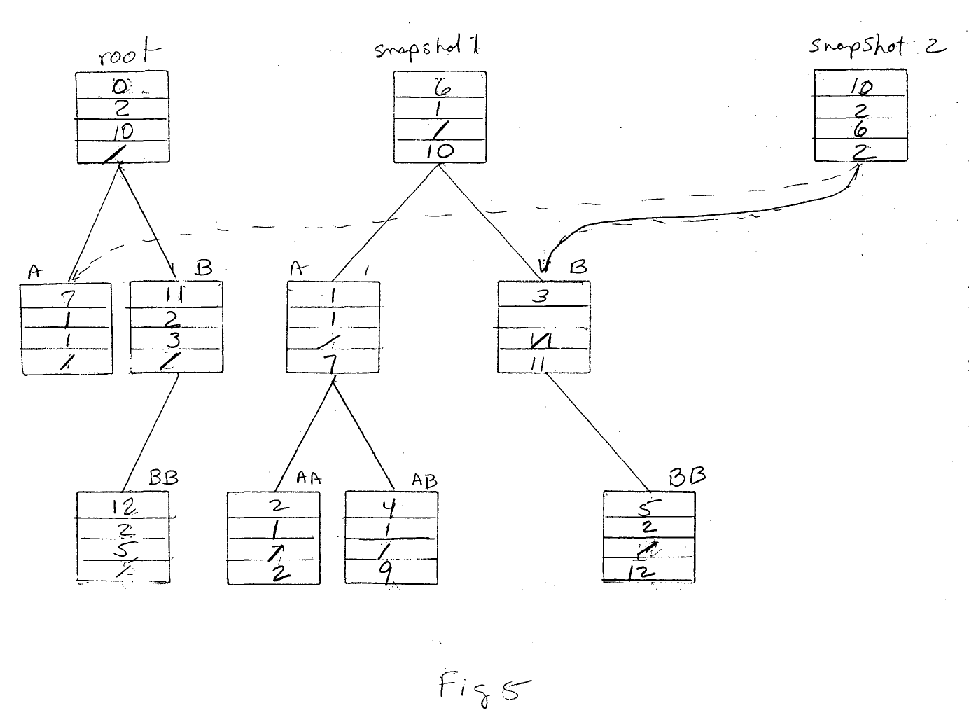

FIG. 5 is a block diagram illustrating data within the hierarchically organized file system after a second snapshot was created in one embodiment. To create the second snapshot, the snapshot system created a new node 10 and incremented the snapshot identifier to 2. The snapshot system then copied the data of root node 0 to the new root node 10. As a result, node 10 pointed to the same child nodes as node 0.

After snapshot 2 was created, the snapshot system received a request to modify node 5. The snapshot system determined that node 3 was the highest ancestor node that had not yet been replaced during snapshot 2. As a result, the snapshot system created a new node 11 to replace node 3 and new node 12 to replace node 5 in much the same way as done when node 2 of FIG. 3 was replaced.

Snapshots 1 and 2 can be accessed by traversing through their respective root nodes. In the example of FIG. 5, all the nodes of a snapshot 1 are snapshot nodes because all the current nodes at the time snapshot 1 was created have since been modified. Snapshot 2 points to some snapshot nodes and some current nodes that have not yet been modified since snapshot 2 was created. By traversing through the root nodes of the snapshots, all the data associated with that snapshot can be located whether the data be stored in a snapshot node or a current node. In addition, different snapshots can share the same snapshot nodes as illustrated by snapshots 1 and 2 sharing node 3.

In one embodiment, the snapshot system stores the mapping between virtual identifiers and actual identifiers in the nodes themselves. The virtual identifier of a node is stored in an “aliased as” field. The snapshot system also stores in an “aliased by” field of each node the actual identifier of the node whose virtual identifier is the same as the actual identifier of this node. The snapshot system provides the virtual identifier from the aliased as field when an application program requests a handle for a node. When the application program then uses the virtual identifier to identify the node to be accessed, the snapshot system retrieves the node whose actual identifier is the same as the virtual identifier and uses its aliased by field to identify the node that should actually be accessed. The snapshot system may use a reserved value (e.g., node identifier of “0”) to indicate that the virtual identifier of a node is the same as its actual identifier. Alternatively, the virtual identifier can be set to the same value as the actual identifier. For example, when a newly created node is added to the current data without replacing an existing node, it can have its virtual identifier be the same as its actual identifier. When the snapshot system replaces a node, the replacing node can be a newly created node or an existing node that has been freed and reused by the file system. If the replacing node is an existing node, then the snapshot system needs to ensure that its aliased as and aliased by fields properly identify the nodes. When the replaced node has a virtual identifier that is the same as the actual identifier of the replacing node, then the snapshot system sets the virtual identifier of the replacing node to its actual identifier, which in one embodiment is indicated by storing a 0 in the aliased as field. When the replaced node has a virtual identifier that is not the same as its actual identifier (e.g., the aliased as field of the replaced node does not contain a 0), then the snapshot system sets the virtual identifier of the replacing node to the virtual identifier of the replaced node. When the replaced node has a virtual identifier that is the same as its actual identifier (e.g., the aliased as field of the replaced node contains a 0) then the snapshot system sets the virtual identifier of the replacing node to the actual identifier of the replaced node. The snapshot system also sets the virtual identifier of a replaced node. When the virtual identifier of the replacing node is the same as the actual identifier of the replaced node, then the snapshot system sets the virtual identifier of the replaced node to its actual identifier. When the replacing node has a virtual identifier that is not the same as the actual identifier of the replaced node, then the snapshot system sets the virtual identifier of the replaced node to the virtual identifier of the replacing node. When the virtual identifier of the replacing node is the same as its actual identifier, then the snapshot system sets the virtual identifier of the replaced node to its actual identifier. The snapshot system also sets the aliased by fields of the nodes to reflect the updated aliased as fields of the nodes.

The following tables contains pseudo code illustrating the logic for setting the aliased as and aliased by fields in one embodiment. Table 1 represents the setting of the virtual identifier of the replacing node, and Table 2 represents the setting of the virtual identifier of the replaced node. The conditions represent values of the fields prior to any changes by the pseudo code. The aliased as field is represented as “as,” and the aliased by field is represented as “by.”

TABLE 1

```
if (replaced.as = replacing.id) then
    replacing.as = 0
    replacing.by = 0
else if (replaced.as <> 0)
    replaced.as->by = replacing.id
    replacing.as = replaced.as
else
    replaced.by = replacing.id
    replacing.as = replaced.id
endif
```

TABLE 2

```
if (replacing.as = replaced.id) then
    replaced.as = 0
    replaced.by = 0
else if (replacing.as <> 0)
    replacing.as->by = replaced.id
    replaced.as = replacing.as
else
    replacing.by = replaced.id
    replaced.as = replacing.id
endif
```

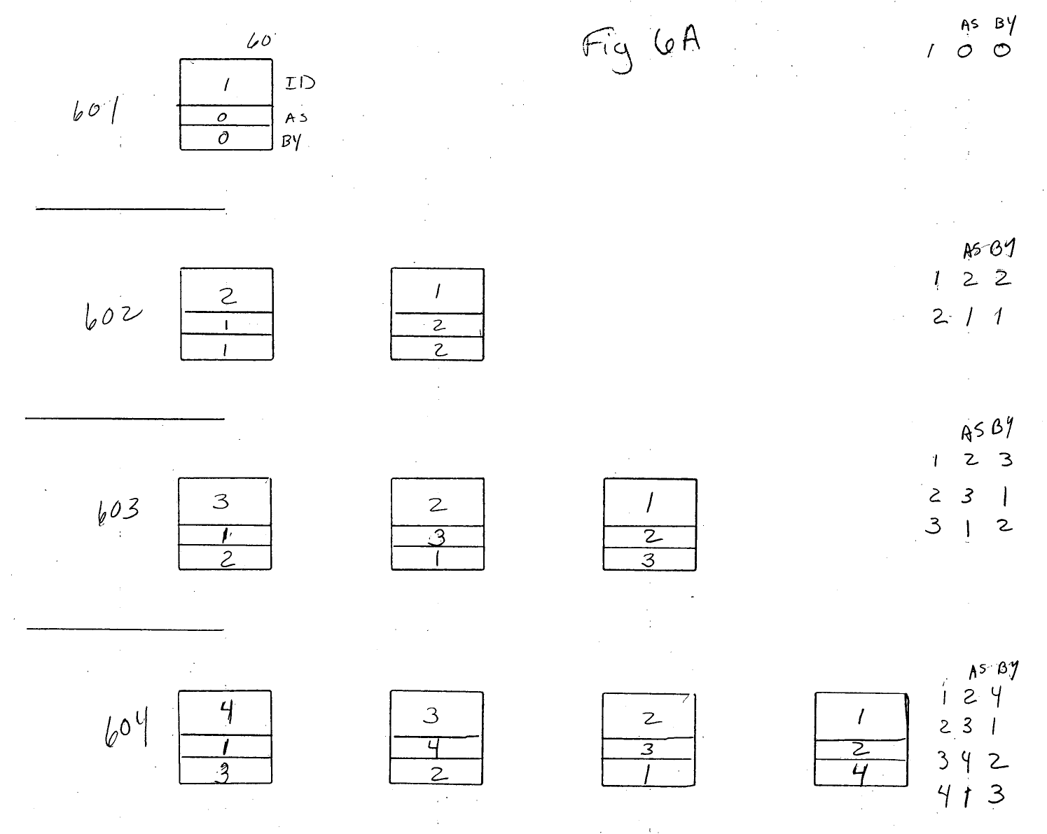

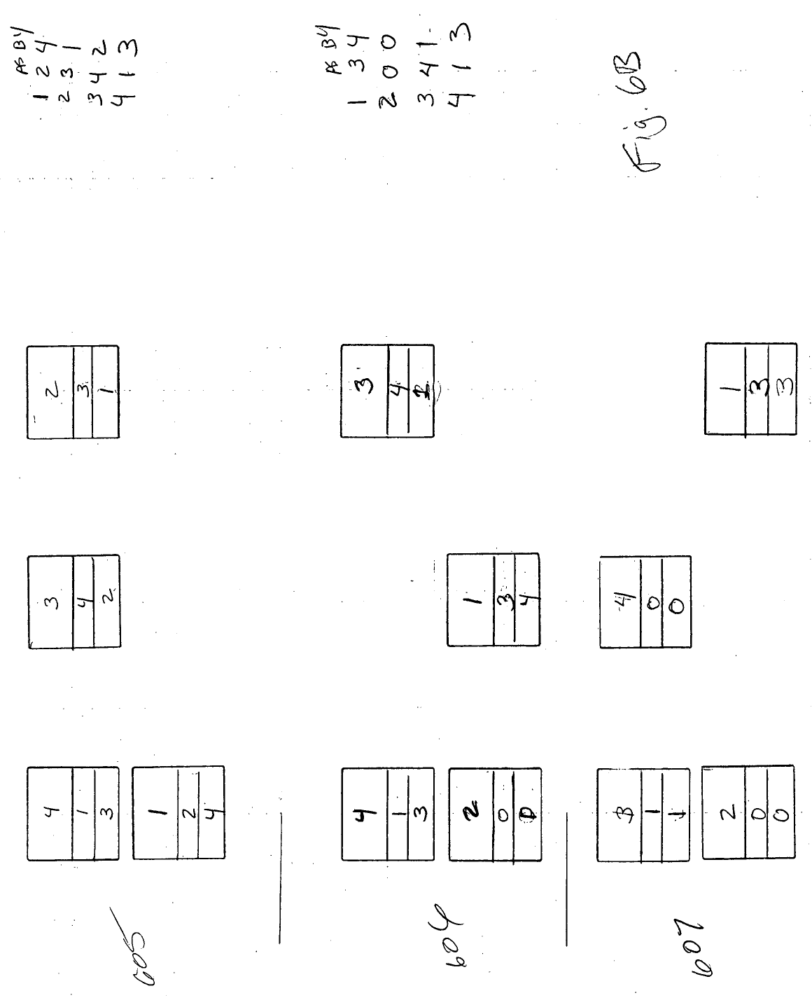

FIGS. 6A and 6B illustrate the setting of the aliased as and aliased by fields in one embodiment. Each square represents a node and contains the identifier, aliased as, and aliased by fields of the node. Line 601 illustrates current data that contains one node, node 1. The aliased as and aliased by fields contain 0 to indicate that the virtual identifier of node 1 is the same as its actual identifier. Line 602 illustrates that the snapshot system has replaced node 1 with node 2. Node 2 represents the current data. Node 2 has its aliased as field set to 1 so that whenever an application program accesses node 2, the snapshot system returns 1 as its virtual identifier. Node 1 has its aliased by field set to 2 so that, whenever the snapshot system receives a virtual identifier of 1, it accesses node 2. The snapshot system also sets a flag in each node that it is part of a snapshot. When a program accesses snapshot data, the snapshot system in one embodiment sets the high-order bit of the identifier that it provides to the program. When the program subsequently accesses the snapshot data (as indicated by the high-order bit being set), the snapshot system can determine that the snapshot data is being accessed, rather than the current data. Line 603 illustrates that the snapshot system has replaced node 2 with node 3. Node 3 has its aliased as field set to 1 so that whenever an application program accesses node 3, the snapshot system returns 1 as its virtual identifier. Whenever node 2, which is now snapshot data, is accessed, the snapshot system returns 3 as its virtual identifier. When an application program accesses a node using the virtual identifier of 3, the snapshot system accesses node 3 and uses its aliased by field to determine that request should be to access node 2. Line 604 illustrates when node 4 replaces node 3. Line 605 illustrates when node 1 has been removed from the snapshot data and reused by the file system to add a new node to the current data. Nodes 1 and 4 are current data. Line 606 illustrates when node 2 has been reused to replace node 1. The snapshot system can now use the actual identifier of node 2 as its virtual identifier. Line 607 illustrates when node 3 is freed up and replaces node 4. The snapshot system can now use the actual identifier of node 4 as its virtual identifier. One skilled in the art will appreciate that the mapping of actual identifier to virtual identifies can be stored in a data structure separate from the nodes. In addition, one skilled in the art will appreciate that although the aliased by information can be derived from the aliased as information, it may improve speed of access to include the aliased by information.

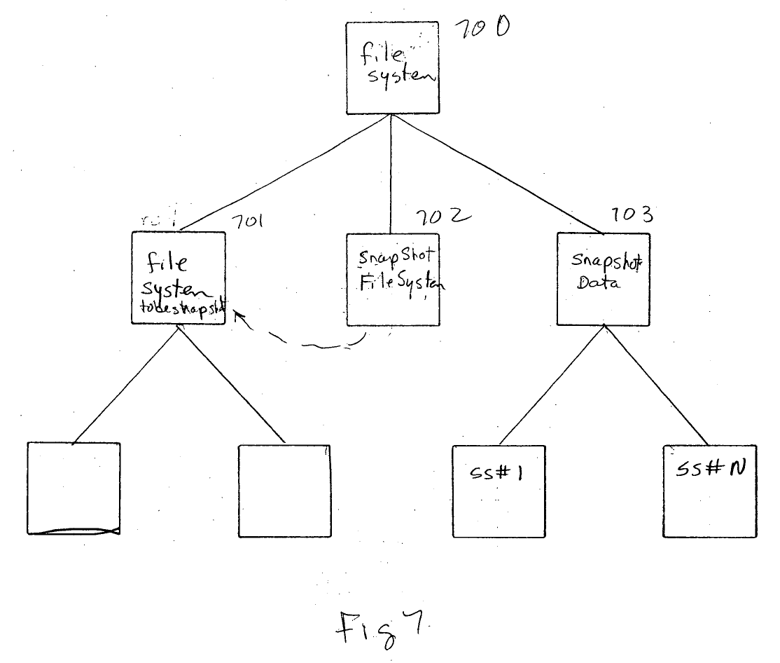

FIG. 7 is a block diagram illustrating the organization of the snapshot system in one embodiment. In this example, the file system 700 has volumes 701, 702, and 703 mounted. File system 701 is the file system for which the snapshots are to be created. Snapshot file system 702 is a file system that effects the creating of snapshots. Requests to access file system 701 are sent through snapshot file system 702, which serves as a front end to file system 701. When the snapshot file system receives a request to create a snapshot or modify data in the file system, it replaces the nodes of the file system 701 as appropriate. The snapshot file system stores the snapshot nodes in the snapshot data 703. The snapshot data 703 may contain a directory for each snapshot. That directory may contain identifying information related to the snapshot, timing information, and a reference to the root node of that snapshot. The snapshot file system 702, after performing the appropriate snapshot-related processing (e.g., mapping virtual identifiers to actual identifiers), forwards the access request to the file system 701 to update the current nodes.

The snapshot system may be implemented on a computer system that may include a central processing unit, memory, input devices (e.g., keyboard and pointing devices), output devices (e.g., display devices), and storage devices (e.g., disk drives). The memory and storage devices are computer-readable media that may contain instructions that implement the snapshot system. In addition, the data structures and message structures may be stored or transmitted via a data transmission medium, such as a signal on a communications link. Various communications links may be used, such as the Internet, a local area network, a wide area network, or a point-to-point dial-up connection. The snapshot system may implemented as part of an existing file system or implemented as a front end to a file system. The snapshot system may take snapshots of the distributed file systems or any scheme for hierarchically organizing data.

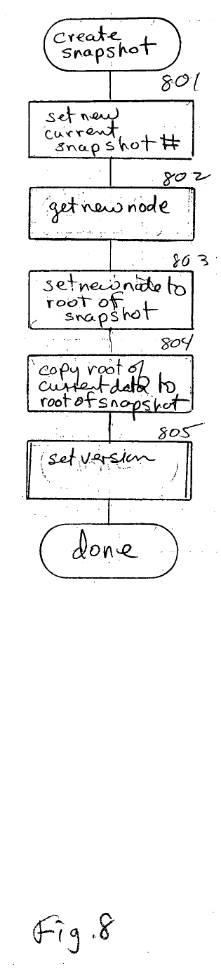

FIG. 8 is a flow diagram illustrating the processing of a create snapshot component of the snapshot system in one embodiment. In block 801, the component sets the new current snapshot identifier. In block 802, the component gets a new node to serve as the root node of the snapshot. In block 803, the component sets the new node to be the root node of the snapshot. In block 804, the component copies the data of the root node of the current data to the root node of the snapshot. In block 805, the component sets the version data (i.e., previous and next fields) and then completes.

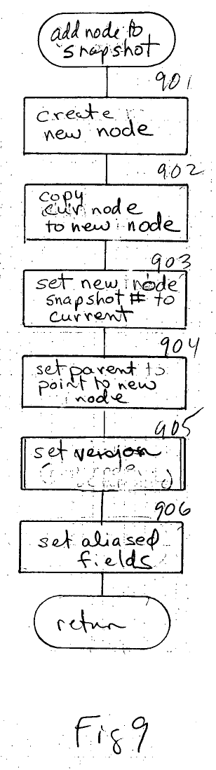

FIG. 9 is a flow diagram illustrating the processing of a component that adds a node to a snapshot in one embodiment. In block 901, the component creates the replacing node. In block 902, the component copies the data of the replaced node to the replacing node. In block 903, the component sets the snapshot identifier field of the replacing node to the current snapshot identifier. In block 904, the component sets the parent, if any, of the replaced node to point to the replacing node. In block 905, the component sets the chain of versions for the nodes. In block 906, the component sets the aliased fields. The component then completes.

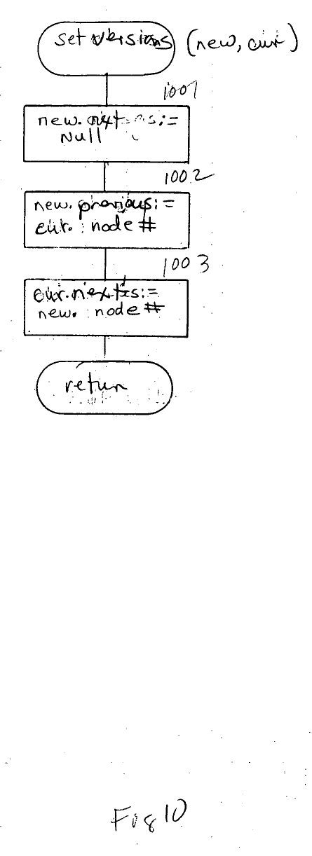

FIG. 10 is a flow diagram illustrating the processing of the set versions component in one embodiment. The component is passed the node identifier of the new and current nodes. In block 1001, component sets the next field of the new node to null. In block 1002, the component sets the previous field of the new node to the node identifier of the current node. In block 1003, the component sets at the next field of the current node to the node identifier of the new node and then returns.

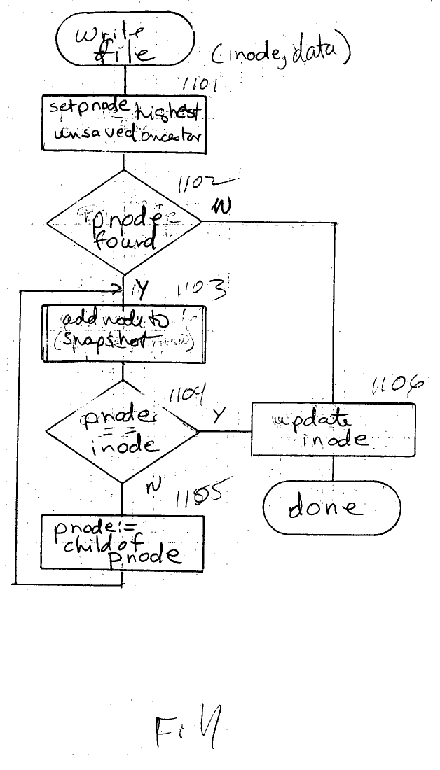

FIG. 11 is a flow diagram illustrating the processing of a component to write to a file in one embodiment. The component is passed an indication of the node to which the passed data is to be written. In block 1101, the component identifies the highest ancestor node that has not yet been replaced during the current snapshot. In decision block 1102, if such an ancestor node has been found or the node itself has not yet been replaced during the current snapshot, then the component continues at block 1103, else the component continues at block 1106. In block 1103-1105, the component loops replacing ancestor nodes and the node itself. In block 1103, the component invokes the add node to snapshot component passing the currently pointed to ancestor node. In decision block 1104, if the currently pointed to ancestor node is the node itself, then the component continues at block 1106, else the component continues at block 1105. In block 1105, the component sets the current ancestor node to the child of the previous current ancestor node and loops to block 1103. In block 1106, the component updates the file data for the current node and then completes.

One skilled in the art will appreciate that although specific embodiments of the snapshot system have been described herein for purposes of illustration, various modifications may be made without deviating from the spirit and scope of the invention. For example, the snapshot system can be used with virtually any file system, including UNIX-based file system and file systems developed by Microsoft, IBM, EMC, ad so on. Accordingly, the invention is defined by the appended claims.

1. A method in a computer system for creating a file system snapshot, the data of the file system being organized hierarchically via nodes, the method comprising:
copying a root node of the file system to a new node that points to the same child nodes of the root node, the new node represents a root node of the snapshot; and
when a node of the file system is modified,
replacing ancestor nodes of the node that have not yet been replaced with a new node;
replacing the node with a new node that points to the same child nodes of the replaced node; and
effecting the modification on the new node.

2. The method of claim 1 wherein when multiple snapshots occur, the ancestor nodes of the node to be modified that are replaced are those ancestor nodes that have not yet been replaced during the current snapshot.

3. The method of claim 2 wherein each new node has a snapshot identifier that identifies the snapshot during which it replaced a node and including checking the snapshot identifier of an ancestor node to determine whether it has been replaced during the current snapshot.

4. The method of claim 3 wherein when a node is not to be part of a snapshot, associating an indication with that node so that node will not be replaced when it or any descendent node is modified.

5. The method of claim 1 wherein when the snapshot is accessed via the root node of the snapshot.

6. The method of claim 1 wherein each new node has an identifier that is different from the identifier of the node it replaced.

7. The method of claim 6 including associating the identifier of the replacing node with the replaced node so that, when a request to access a node identified by the identifier of the replaced node is received, that association is used to access the replacing node.

8. The method of claim 7 wherein the associating includes storing the identifier of the new node in the replaced node.

9. The method of claim 7 including associating the identifier of the replaced node with the replacing node so that, when the identifier of the replacing node is requested, that association is used to provide the identifier of the replaced node.

10. The method of claim 1 wherein each node has a reference count that includes a count of the snapshots through which the node is accessible.

11. The method of claim 1 wherein the file system is a Unix-based file system.

12. The method of claim 11 wherein a snapshot identifier is stored within each node.

13. The method of claim 11 wherein a snapshot identifier is stored as an attribute of each node.

14. The method of claim 1 wherein a virtual identifier is stored within a node.

15. The method of claim 1 wherein a virtual identifier is stored as an attribute of a node.

16. The method of claim 1 wherein when a file is modified, the new node associated with that file is set to reference the data for the modified file, rather than the data for the unmodified file.

17. The method of claim 1 wherein when a block of a file is modified, the new node associated with that file is set to reference a block that contains the modified block, rather than the block that contains the unmodified data.

18. The method of claim 17 including reference counting each snapshot that refers to a block so that the block can be removed when there are no more references to the block.

19. The method of claim 18 including when the reference counting is performed using a table external to the block.

20. The method of claim 19 wherein the table includes for each block a bit for each snapshot that indicates whether the block is referenced by the snapshot.
